(19) United States
(12) Patent Application Publication
(10) Pub. No.: US 2026/0026466 A1
(43) Pub. Date: Jan. 29, 2026

(54) FEEDER

(71) Applicant: LG ELECTRONICS INC., Seoul (KR)

(72) Inventor: Insu SONG, Seoul (KR)

(73) Assignee: LG ELECTRONICS INC., Seoul (KR)

(21) Appl. No.: 19/277,225

(22) Filed: Jul. 22, 2025

(30) Foreign Application Priority Data
Jul. 24, 2024 (WO) PCT/KR2024/010735

(51) Int. Cl. A01K 5/01; A01K 5/02

(52) U.S. Cl. CPC A01K 5/0114; A01K 5/0233; A01K 5/0241; A01K 5/0258

(57) ABSTRACT

Disclosed is a feeder. The feeder includes a transfer housing having an opening; a transfer portion rotatable within the transfer housing; a first gear transmitting power to the transfer portion; a motor providing power to the first gear; a second gear receiving power from the motor; and a feeding head which is adjacent to the opening of the transfer housing, and moves by a power transmitted by the second gear, wherein when the motor provides rotational power in a first direction, the feeding head moves, and, when the motor provides rotational power in a second direction opposite to the first direction, the movement of the feeding head stops and the transfer portion rotates.

### CROSS-REFERENCE TO RELATED APPLICATION(S)

Pursuant to 35 U.S.C. § 119, this application claims the benefit of earlier filing date and right of priority to International Application No. PCT/KR2024/010735, filed on Jul. 24, 2024, the contents of which are all incorporated by reference herein in its entirety.

### TECHNICAL FIELD

This disclosure relates to a feeder, and more particularly, to a device for providing food to an animal.

### BACKGROUND

As the size of the pet-related market increases, research and development on pet-related supplies and products has been actively conducted. As people increasingly consider pets as family members, the pet-related industry is expected to grow further in the future.

Pet health management is expected to be one of the future promising industries, and many studies have been conducted to prevent or diagnose diseases of pets by managing the health status of pets.

In this regard, many studies have conducted on a feeder (food provider) that supplies food to pets.

### SUMMARY

The disclosure has been made in view of the above problems, and may provide a feeder for an animal.

The disclosure may further provide a feeder that automatically supplies food to a pet.

The disclosure may further provide a hygienic feeder.

The disclosure may further provide a feeder that allows a user to control a single food intake.

The disclosure may further provide a feeder having improved safety of use.

The disclosure may further provide a feeder that can implement two types of driving with a single motor.

In accordance with an aspect of the present disclosure, a feeder includes a transfer housing having an opening; a transfer portion rotatable within the transfer housing; a first gear transmitting power to the transfer portion; a motor providing power to the first gear; a second gear receiving power from the motor; and a feeding head which is adjacent to the opening of the transfer housing, and moves by a power transmitted by the second gear, wherein when the motor provides rotational power in a first direction, the feeding head moves, and, when the motor provides rotational power in a second direction opposite to the first direction, the movement of the feeding head stops and the transfer portion rotates.

### BRIEF DESCRIPTION OF THE DRAWINGS

The above and other objects, features and advantages of the present disclosure will be more apparent from the following detailed description in conjunction with the accompanying drawings, in which:

FIGS. 1 to 23 are drawings illustrating examples of a feeder according to embodiments of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present.

A singular representation may include a plural representation unless context clearly indicates otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

The direction indications of up U, down D, left Le, right Ri, front F, and rear R shown in the drawings are only for the convenience of explanation, and the technical concepts disclosed in this specification are not limited thereby.

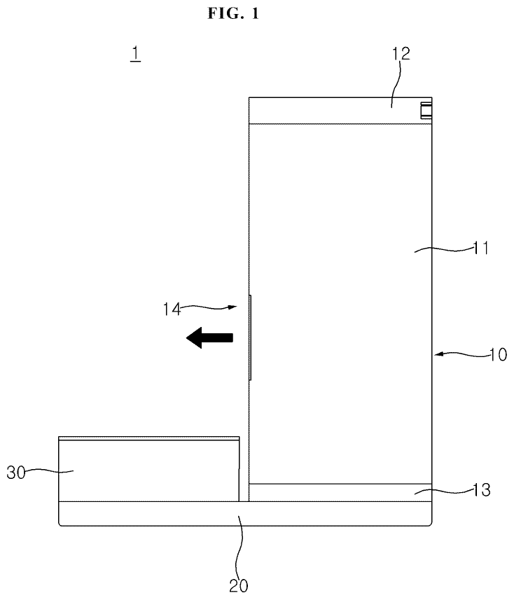

Referring to FIGS. 1 to 3, a feeder 1 may refer to a device that supplies a substance stored inside to the outside. A user may store a desired substance in the feeder 1, and the feeder 1 may supply the stored substance to the user in multiple portions. The feeder 1 may store and supply not only solid substances but also liquid substances or gaseous substances.

The feeder 1 may supply a specific amount of the stored substance to a user when a certain condition value is achieved. For example, the feeder 1 may supply a set amount of the stored substance to a user when the user presses a button or the user's body is detected by a sensor. Alternatively, the feeder 1 may supply a set amount of the stored substance at regular intervals.

The present disclosure describes an embodiment of the feeder 1 that supplies food to a pet, but is not limited thereto, and a user may supply other substances from the feeder 1 depending on the purpose of use. The feeder 1 may be referred to as a divider 1, a provider 1, a feeding device 1, a food provider 1, a food dispenser 1, a dispensing device 1, etc.

The feeder 1 may include a main body 10. The main body 10 may store food and distribute the stored food. The main body 10 may be referred to as a tower 10. The main body 10 may include a tower housing 11, a top cover 12, and a bottom mount 13. The tower housing 11 may have a cylindrical shape, and may provide an accommodation space therein. The tower housing 11 may be coupled or fixed on the bottom mount 13. The top cover 12 may be coupled or fixed to the tower housing 11 while covering the upper opening of the tower housing 11.

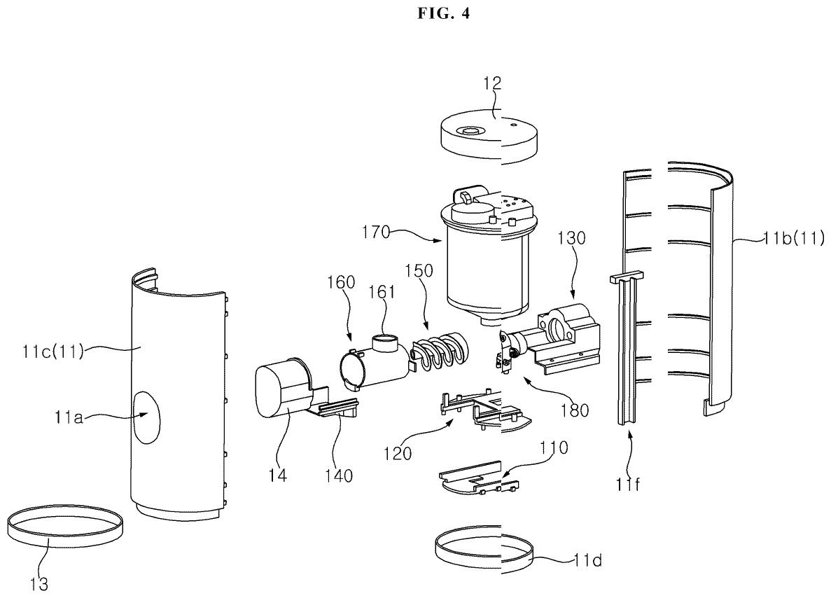

The main body 10 may be mounted or fixed on the base tray 20. A bowl 30 may be adjacent to the main body 10, and may be mounted or fixed on a base tray 20. A feeding head 14 may be positioned on the side surface of the tower housing 11. The feeding head 14 may open and close an opening 11a (see FIG. 4) on the side surface of the tower housing 11. The feeding head 14 may protrude outward from the opening 11a (see FIG. 4) on the side surface of the tower housing while moving.

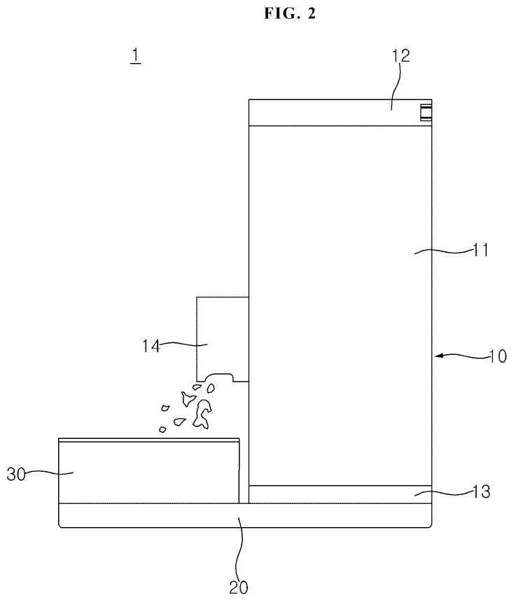

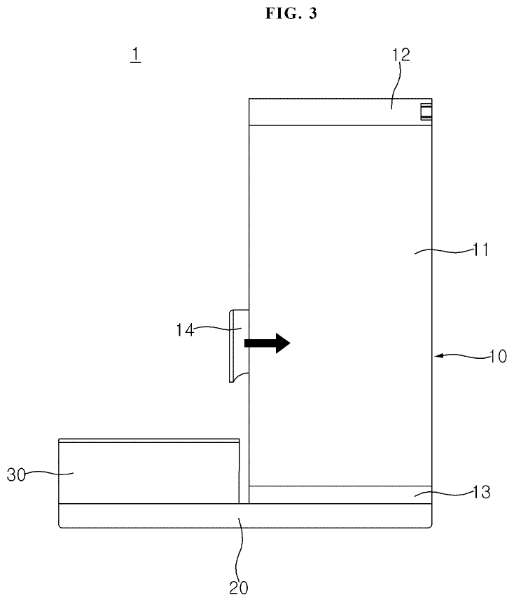

The feeding head 14 may block the opening 11a (see FIG. 4) of the tower housing 11 (see FIG. 1). The feeding head 14 may protrude from the opening 11a (see FIG. 4) of the tower housing 11 to the outside of the tower housing 11, and may supply food or feed (see FIG. 2). The feeding head 14 moves from the opening 11a (see FIG. 4) of the tower housing 11 to the inside of the tower housing 11, and may block the opening 11a (see FIG. 4) of the tower housing 11 (see FIG. 3).

Referring to FIG. 4, the tower housing 11 may include a first part 11b and a second part 11c. The first part 11b of the tower housing 11 may have a half-pipe shape. The second part 11c of the tower housing 11 may have a half-pipe shape. The first part 11b may be coupled with the second part 11c. A housing fixing member 11f may connect the first part 11b and the second part 11c of the tower housing 11 to each other. The housing fixing member 11f may be fixed to the inner surface of the first part 11b and the second part 11c.

A base ring 11d may be positioned at the bottom of the tower housing 11 inside the tower housing 11. A lower base 110 may be positioned on the base ring 11d. The lower base 110 may be mounted on the base ring 11d. An upper base 120 may be positioned on the lower base 110, and may be connected to the lower base 110.

A pop-up unit 14, 140 may include a feeding head 14 and a moving base 140. The moving base 140 may slide between the lower base 110 and the upper base 120. The feeding head 14 may be coupled or fixed to the moving base 140. The feeding head 14 may be positioned in the opening 11a of the tower housing 11, and may go out through the opening 11a or cover the opening 11a.

A driving unit 180 may be coupled to the driving housing 130. The driving unit 180 may be positioned inside the driving housing 130. A driving housing 130 may cover the driving unit 180. The driving housing 130 may be mounted on the upper base 120. A transfer housing 160 may be positioned between the pop-up unit 14, 140 and the driving housing 130. The transfer housing 160 may be coupled or fixed to the driving housing 130. A transfer portion 150 may be inserted into the inside of the transfer housing 160. For example, the transfer portion 150 may be a helical screw.

A container 170 may store food or feed. The container 170 may supply food or feed into the inside of the transfer housing 160 through an opening 161 formed in the upper portion of the transfer housing 160. The container 170 may be positioned in the upper portion of the tower housing 11, and may be covered by the first part 11b and the second part 11c of the tower housing 11. The upper portion of the container 170 may be covered by the top cover 12. The lower portion of the first part 11b and the second part 11c of the tower housing 11 may be inserted into the bottom mount 13. For example, the bottom mount 13 may be a circular band.

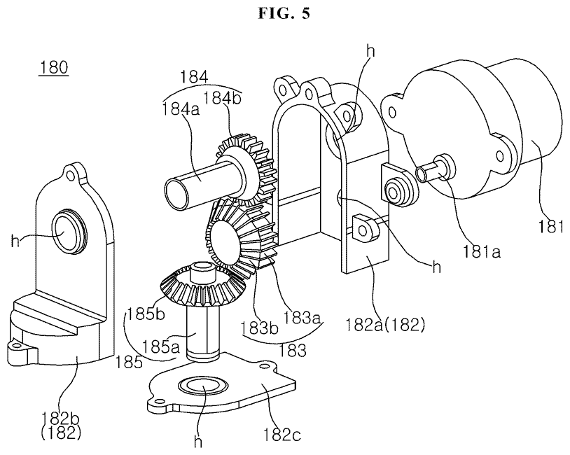

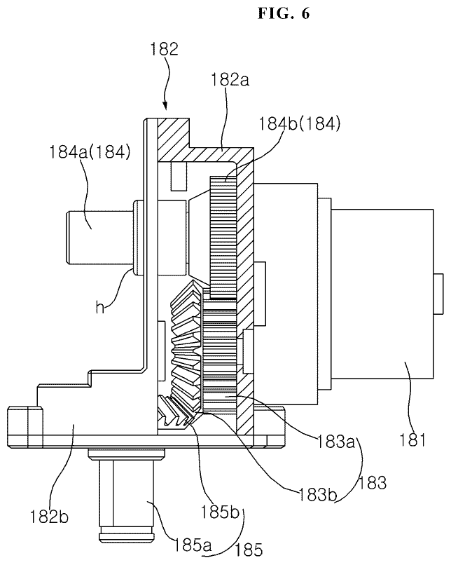

Referring to FIGS. 5 and 6, the driving unit 180 may include a motor 181, a gearbox 182, and a gear set 183, 184, 185. The gearbox 182 may include a front case 182b, a rear case 182a, and a bottom case 182c. The rear case 182a provides a space for accommodating the gear set 183, 184, 185, and the front case 182b and/or the bottom case 182c may be coupled to the rear case 182a.

The rear case 182a may include a plurality of holes h. The plurality of holes h may be disposed in the up-down direction. The motor 181 may be positioned outside the rear case 182a. A motor shaft 181a may be inserted into the lower hole h of the rear case 182a and rotated.

A composite gear 183 may include a spur gear 183a and a bevel gear 183b. The spur gear 183a of the composite gear 183 may be referred to as a first part gear 183a, and the bevel gear 183b of the composite gear 183 may be referred to as a second part gear 183b. The composite gear 183 may be positioned between the rear case 182a and the front case 182b, and may be fixed to the motor shaft 181a. The motor 181 may rotate the composite gear 183. The composite gear 183 may have the bevel gear 183b formed at the front and the spur gear 183a formed at the rear.

A first shaft 184a may be positioned above the composite gear 183, and may be inserted into the upper hole h of the rear case 182a and the hole h of the front case 182b to rotate. The first shaft 184a may be referred to as a transfer drive shaft 184a. The first shaft 184a may include a spur gear 184b or may be connected to the spur gear 184b. The spur gear 184b of the first shaft 184a may be engaged with the spur gear 183a of the composite gear 183. When the composite gear 183 is rotated by the motor 181a, the first shaft 184a may also rotate. The spur gear 183a of the composite gear 183 may be referred to as a first spur gear 183a, and the spur gear 184b of the first shaft 184a may be referred to as a second spur gear 184b.

A second shaft 185a may be inserted into the hole h of the bottom case 182c and rotate. The second shaft 185a may be referred to as a pop-up drive shaft 185a. The second shaft 185a may include a bevel gear 185b or be connected to the bevel gear 185b. The bevel gear 185b of the second shaft 185a may be engaged with the bevel gear 183b of the composite gear 183. When the composite gear 183 rotates by the motor 181, the second shaft 185a may also rotate. The power provided by the motor 181 may be transmitted to the first shaft 184a and/or the second shaft 185a to rotate the first shaft 184a and/or the second shaft 185a.

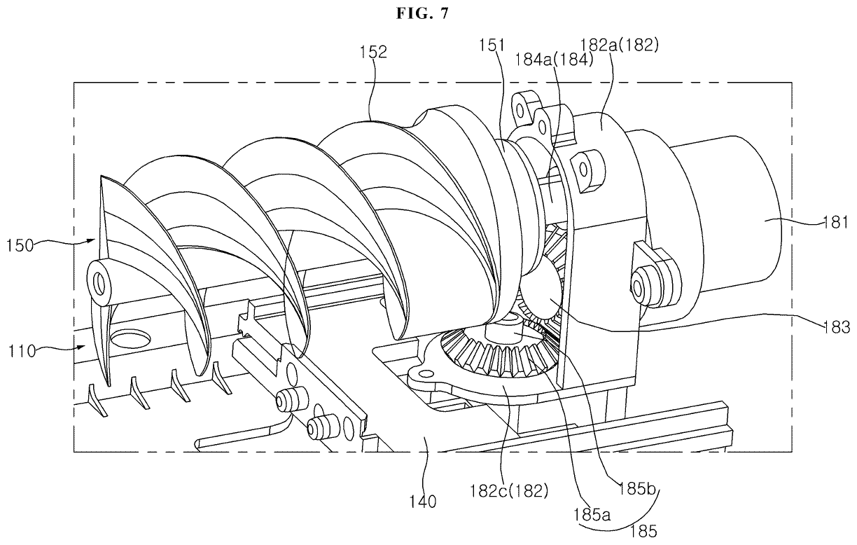

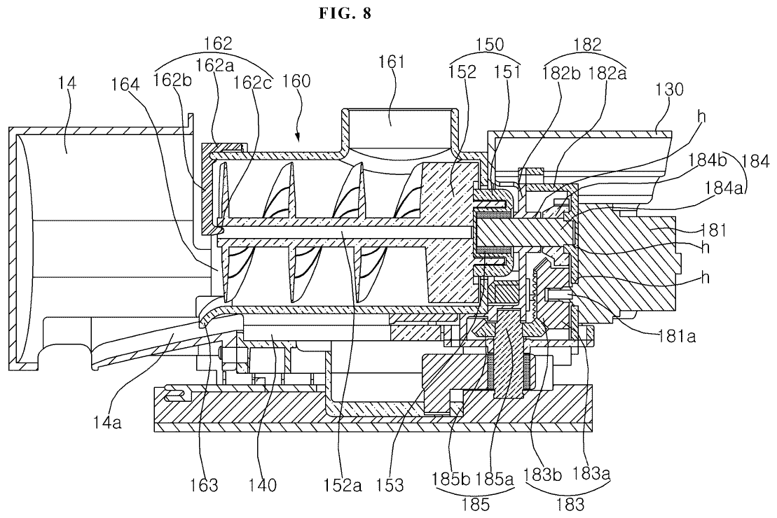

Referring to FIGS. 7 and 8, the transfer portion 150 may include a hub 151 and a screw 152. The first shaft 184a may be inserted into the hub 151. The first bearing 153 may be positioned between the hub 151 and the first shaft 184a. The first bearing 153 may be inserted into the hub 151, and the first shaft 184a may be inserted into the first bearing 153. For example, the first bearing 153 may be a unidirectional bearing. For example, when the first shaft 184a rotates counterclockwise, the hub 151 may also rotate counterclockwise by the first bearing 153. For another example, when the first shaft 184a rotates clockwise, the hub 151 may not rotate by the first bearing 153. For example, the first bearing 153 may rotate by transmitting the rotational force of the first shaft 184a to the hub 151 in the counterclockwise direction, and may idle without transmitting the rotational force of the first shaft 184a in the clockwise direction.

The screw 152 may be fixed to the hub 151 and may rotate together with the hub 151. The screw 152 may have a hollow rotation shaft 152a. The screw 152 may rotate away from the inner surface of the transfer housing 160.

A shaft anchor 162 may be coupled to the transfer housing 160 to hold the hollow rotation shaft 152a of the screw 152. The shaft anchor 162 may include a first part 162a, a second part 162b, and a third part 162c. The first part 162a may be fixed to the outside of the transfer housing 160. The second part 162b may extend from the first part 162a in the radial direction of the screw 152. The third part 162c may protrude from the second part 162b and be inserted into the hollow rotation shaft 152a of the screw 152. The screw 152 may rotate as the hollow rotation shaft 152a of the screw 152 rubs against the third part 162c of the shaft anchor 162. The first part 162a of the shaft anchor 162 may be pivotally coupled to the outer surface of the transfer housing 160. The shaft anchor 162 may be pivoted to separate the screw 152 from the transfer housing 160 and/or the first shaft 184a for cleaning. Alternatively, the shaft anchor 162 may be pivoted to separate the screw 152 from the transfer housing 160 and/or the hub 151 for cleaning.

The feeding head 14 may be aligned with a front opening 164 of the transfer housing 160. Substance flowed in through the upper opening 161 of the transfer housing 160 may be conveyed to the front opening 164 of the transfer housing 160 by rotation of the screw 152. The substance transferred to the front opening 164 of the transfer housing 160 may be moved to the feeding head 14 by the inclined surface 163 at the lower end of the front opening 164 of the transfer housing 160. The substance moved to the feeding head 14 may be moved from the rear of the feeding head 14 to the front by the lower inclined surface 14a of the feeding head 14.

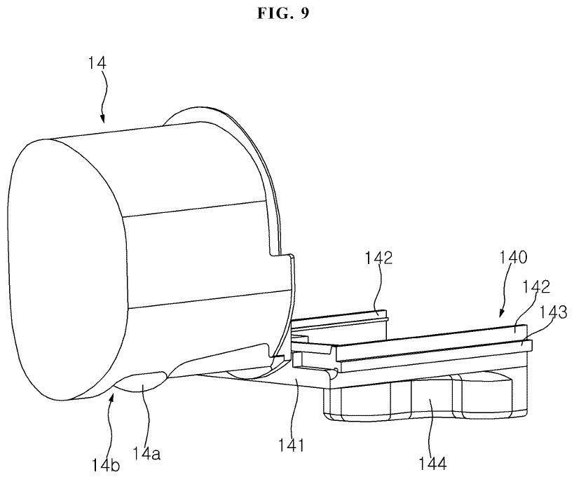

Referring to FIG. 9, the feeding head 14 may be detachably coupled to the moving base 140. In order to clean the contamination of the feeding head 14 that may occur while discharging food or feed, the feeding head 14 may be separated from the moving base 140. The feeding head 14 may include a discharge opening 14b and a slip inclined surface 14a.

The feeding head 14 may have a hollow cap shape. The feeding head 14 may cover the front opening 164 (see FIG. 8) of the transfer housing 160 (see FIG. 8). The transfer housing 160 may be inserted into the inside of the feeding head 14. The discharge opening 14b may be formed on the lower surface of the feeding head 14. The slip inclined surface 14a may be positioned between the discharge opening 14b and the front opening 164 of the transfer housing 160. The slip inclined surface 14a may be connected to the discharge opening 14b. The substance coming out of the front opening 164 of the transfer housing 160 may be discharged to the outside of the feeding head 14 through the discharge opening 14b while slipping on the slip inclined surface 14a of the feeding head 14.

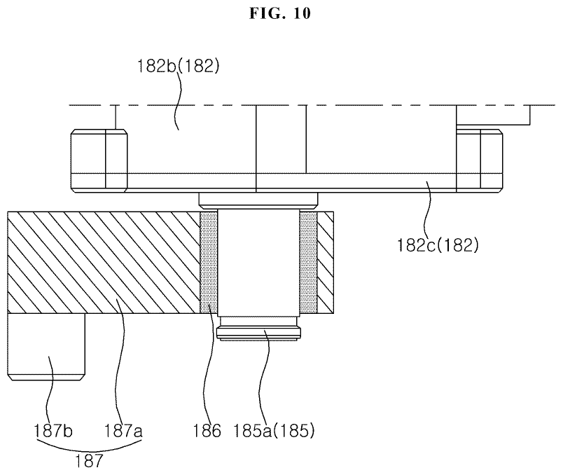

Referring to FIG. 10, a crank 187 may include a body 187a and a pin 187b. The crank body 187a may be coupled to a second shaft 185a. A second bearing 186 may be coupled to between the crank body 187a and the second shaft 185a. The second shaft 185a may be inserted into the second bearing 186, and the second bearing 186 may be inserted into the crank body 187a. For example, the second bearing 186 may be a unidirectional bearing. For example, when the second shaft 185a rotates clockwise, the second bearing 186 may not transmit the rotational force of the second shaft 185a to the crank body 187a and may idle. For another example, when the second shaft 185a rotates counterclockwise, the second bearing 186 may transmit the rotational force of the second shaft 185a to the crank body 187a, so that the crank body 187a may also rotate around the second shaft 185a.

The crank pin 187b may be formed on one side of the crank body 187a. The crank pin 187b may be parallel to the second shaft 185a. The crank pin 187b may face from the crank body 187a towards a downward side of the crank body 187a.

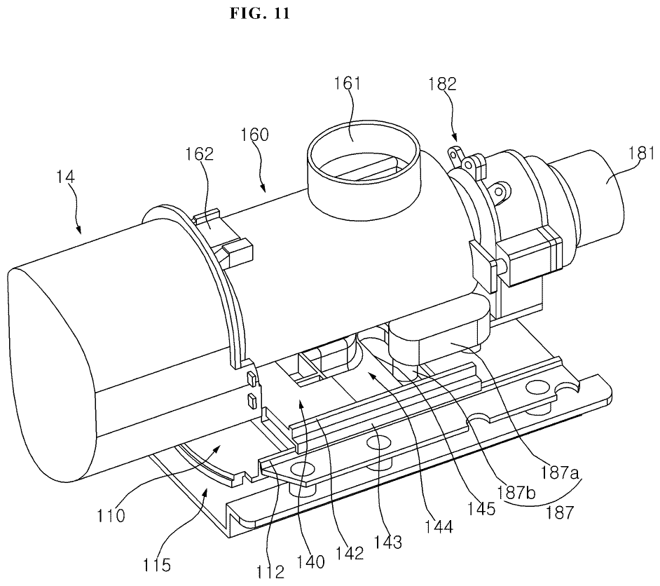

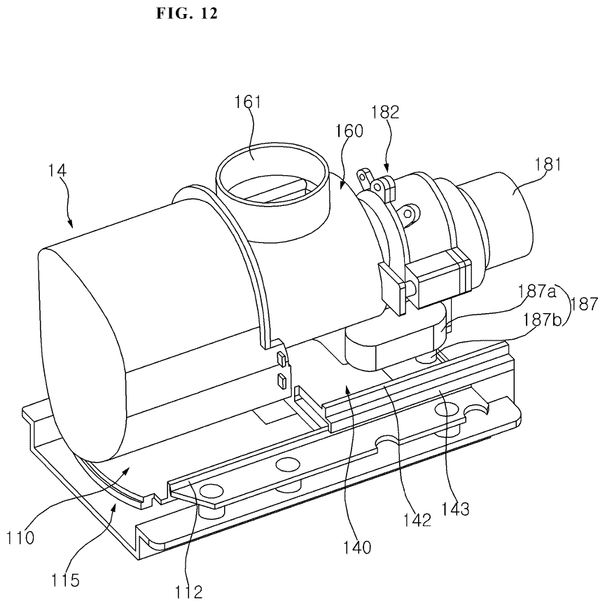

Referring to FIGS. 11 and 12, the lower base 110 may be coupled or fixed on the mount base 115. The moving base 140 coupled to the feeding head 14 may reciprocally move on the lower base 110. The lower base 110 may have a side rail 112. The moving base 140 may move on the side rail 112 of the lower base 110. The moving base 140 may include a side slider 142, 143. The side slider 142, 143 of the moving base 140 may slide on the side rail 112 of the lower base 110.

The crank pin 187b may be inserted into a pin loader 145 formed in a crank case 144 of the moving base 140. The crank case 144 may provide a space for accommodating the crank body 187a. The pin loader 145 may form a step lowered from the bottom surface of the crank case 144. The crank pin 187b may rub against the pin loader 145.

When the crank body 187a rotates by the rotation of the second shaft 185a (see FIG. 10), the crank pin 187b may rub against the pin loader 145 in the pin loader 145. Accordingly, the moving base 140 and the feeding head 14 may reciprocally move in the length direction of the screw 152 (see FIG. 8) with respect to the transfer housing 160.

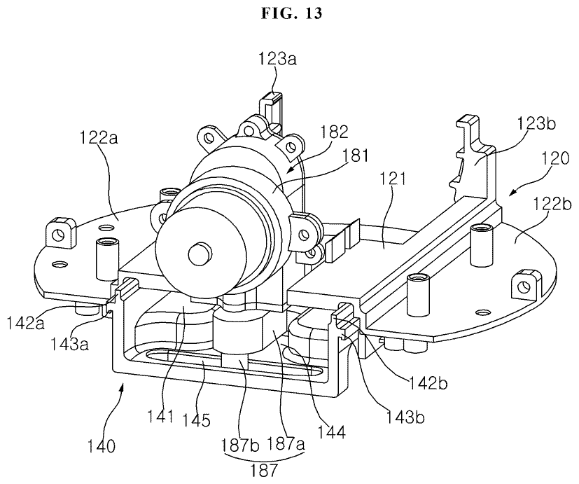

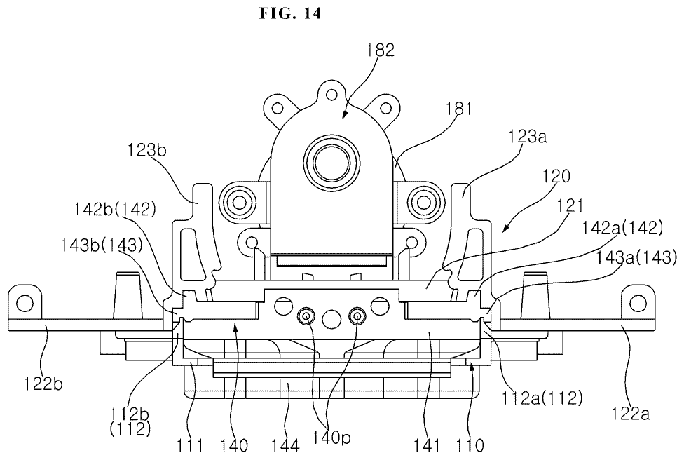

Referring to FIGS. 13 and 14, the lower base 110 may include a first side rail 112a and a second side rail 112b. The first side rail 112a may be positioned opposite to the second side rail 112b with respect to the moving base 140. The first side rail 112a may be parallel to the second side rail 112b. The side rails 112 may form a wall on both sides of a flat plate 111 of the lower base 110.

The upper base 120 may have wings 122a, 122b on both sides of a flat plate 121. The first wing 122a may be positioned opposite to the second wing 122b with respect to the flat plate 121 of the upper base 120. The wings 122a, 122b may have a fan shape corresponding to the curvature of the tower housing 11 (see FIG. 4). The upper base 120 may have guide poles 123a, 123b. The guide poles 123a, 123b may be positioned on the flat plate 121 of the upper base 120.

The moving base 140 may slide between the lower base 110 and the upper base 120. The moving base 140 may include a first side slider 142a, 143a and a second side slider 142b, 143b. The first side slider 142a, 143a may be positioned on the first side rail 112a, and the second side slider 142b, 143b may be positioned on the second side rail 112b. The side sliders 142, 143 may form a wall on both sides of the flat plate 141 of the moving base 140. The moving base 140 may include a coupling protrusion 140P inserted into the feeding head 4 (see FIG. 9). The coupling protrusion 140P may be press-fitted into the feeding head 14. The feeding head 14 coupled to the moving base 140 by inserting the coupling protrusion 140P may be separated from the moving base 140.

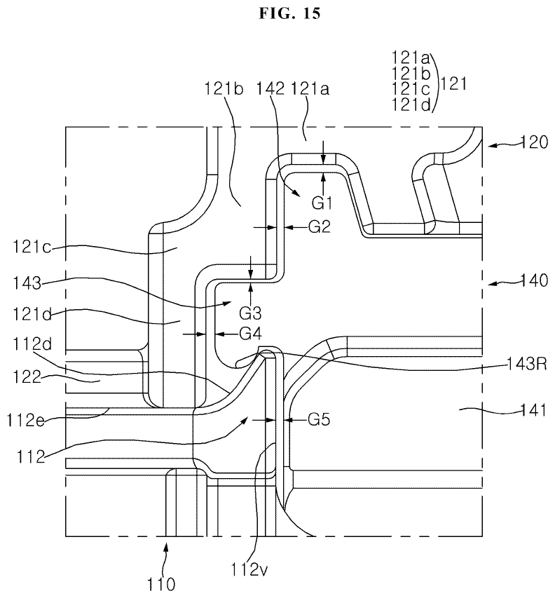

Referring to FIG. 15 together with FIG. 14, the side rail 112 of the lower base 110 may include a vertical portion 112v and an inclined portion 112d. The vertical portion 112v of the side rail 112 may face the side surface of the flat plate 141 of the moving base 140. The inclined portion 112d of the side rail 112 may be formed from the upper end of the vertical portion 112v toward the outer side of the lower base 110. The upper end of the inclined portion 112d of the side rail 112 and the upper end of the vertical portion 112v of the side rail 112 may be connected and rounded. The lower base 110 may include a side flat portion 112e connected to the inclined portion 112d of the side rail 112.

The side slider 142, 143 of the moving base 140 may include a lower slider 143 and an upper slider 142. The upper slider 142 may extend upward from the flat plate 141 of the moving base 140. The lower slider 143 may extend and protrude from the side surface of the upper slider 142 and/or the flat plate 141 toward the outside of the moving base 140. The lower slider 143 may include a rounding part 143R that protrudes downward. The rounding part 143R may be spaced from the side surface of the upper slider 142 and/or the flat plate 141 of the moving base 140.

The upper base 120 may include a side rail cover 121 corresponding to the outer surface of the side slider 142, 143. The side rail cover 121 may include a first rail cover 121a, a second rail cover 121b, a third rail cover 121c, and a fourth rail cover 121d.

The first rail cover 121a may face the upper surface of the upper slider 142 of the side slider 142, 143. The second rail cover 121b may face the side surface of the upper slider 142 of the side slider 142, 143. The third rail cover 121c may face the upper surface of the lower slider 143 of the side slider 142, 143. The fourth rail cover 121d may face the side surface of the lower slider 143 of the side slider 142, 143. The fourth rail cover 121d may be supported by or in contact with the side flat portion 112e of the lower base 110.

A first gap G1 may be formed between the lower surface of the first rail cover 121a and the upper surface of the upper slider 142. A second gap G2 may be formed between the inner surface of the second rail cover 121b and the outer surface of the upper slider 142. A third gap G3 may be formed between the lower surface of the third rail cover 121c and the upper surface of the lower slider 143. A fourth gap G4 may be formed between the inner surface of the fourth rail cover 121d and the outer surface of the lower slider 143. The rounding part 143R of the lower slider 143 may be supported by or in contact with the inclined portion 112d of the side rail 112 of the lower base 110. For example, the rounding part 143R of the lower slider 143 may be in line-contact with the inclined portion 112d of the side rail 112 of the lower base 110. A fifth gap G5 may be formed between the vertical portion 112v of the side rail 112 of the lower base 110 and the outer surface of the flat plate 141 of the moving base 140.

The third gap G3 may be smaller than the first gap G1, the second gap G2, or the fourth gap G4. The fifth gap G5 may be smaller than the fourth gap G4. The third gap G3 may be smaller than the fifth gap G5.

Accordingly, the moving base 140 may move smoothly between the lower base 110 and/or the upper base 120, and noise caused by friction may be reduced. In addition, the wear that is caused as the moving base 140 repeatedly moves between the lower base 110 and/or the upper base 120 may be improved.

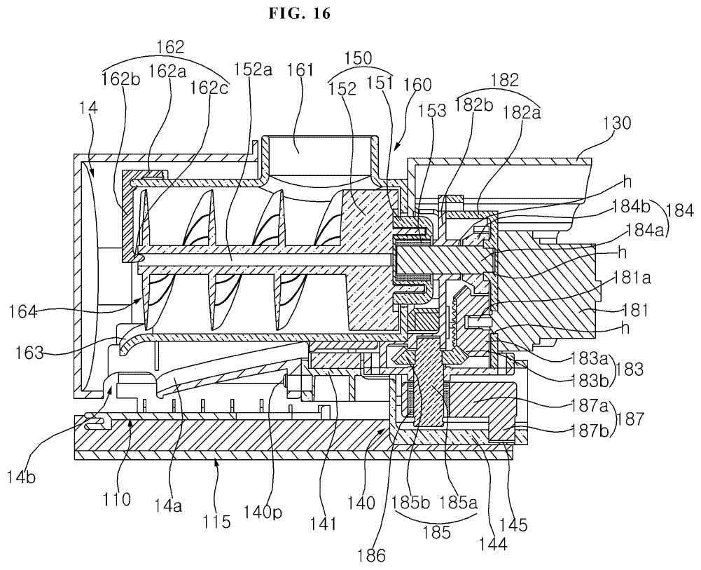

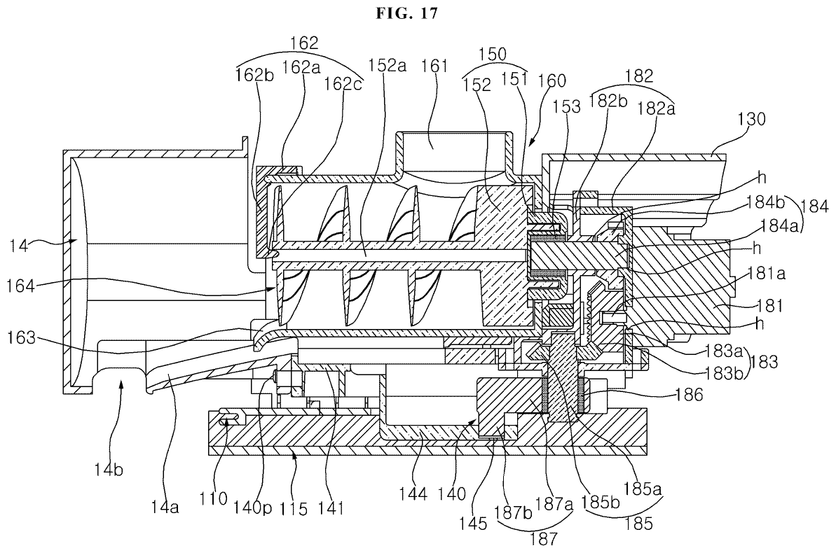

Referring to FIGS. 16 and 17, the rotational force generated from the motor 181 may be transmitted to the composite gear 183 that rotates together with the motor shaft 181a. The first shaft 184a may rotate while the spur gear 184b of the first shaft 184a that is engaged with the spur gear 183a of the composite gear 183 rotates together with the spur gear 183a of the composite gear 183. The first shaft 184a may be inserted into the hub 151 and may transmit the rotational force of the first shaft 184a to the hub 151. At this time, the first bearing 153 may selectively transmit the rotational force of the first shaft 184a to the hub 151.

In addition, the second shaft 185a may rotate while the bevel gear 185b of the second shaft 185a that is engaged with the bevel gear 183b of the composite gear 183 rotates together with the bevel gear 183b of the composite gear 183. At this time, the second bearing 186 may selectively transmit the rotational force of the second shaft 185a to the crank body 187a.

For example, when the composite gear 183 rotates counterclockwise, the first shaft 184a may rotate clockwise. At this time, the first bearing 153 may not transmit the clockwise rotation of the first shaft 184a to the hub 151 and may idle, so that the screw 152 may not rotate. At the same time, when the composite gear 183 rotates counterclockwise, the bevel gear 185b of the second shaft 185a that is engaged with the bevel gear 183b of the composite gear 183 rotates, so that the second shaft 185a may rotate. Then, the second bearing 186 transmits the rotation of the second shaft 185a to the crank body 187a, so that the crank body 187a pivots around the second shaft 185a and the crank pin 187b may move circularly. The crank pin 187b rubs against the pin loader 145, and the position of the pin loader 145 moves from the rear to the front, so that the moving base 140 and the feeding head 14 may move from the rear to the front.

For another example, when the moving base 140 and the feeding head 14 move from the rear to the front, and then the composite gear 183 rotates clockwise, the first shaft 184a may rotate counterclockwise. Then, the first bearing 153 may transmit the counterclockwise rotation of the first shaft 184a to the hub 151, and the screw 152 may rotate.

At the same time, when the composite gear 183 rotates clockwise, the bevel gear 185b of the second shaft 185a that is engaged with the bevel gear 183b of the composite gear 183 rotates, so that the second shaft 185a may rotate. Then, the second bearing 186 may idle without transmitting the rotation of the second shaft 185a to the crank body 187a.

Accordingly, the rotation direction of the motor shaft 181a may be controlled through a single motor 181 to realize the rotation of the screw 152 and the pop-up operation of the feeding head 14.

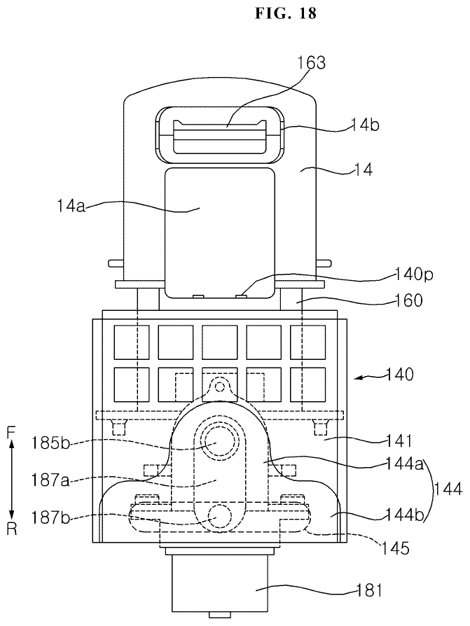

Referring to FIG. 18 together with FIG. 16, when the second shaft 185b is positioned in the front F of the crank pin 187b with respect to the crank body 187a, the feeding head 14 may cover the front opening 164 (see FIG. 16) of the transfer housing 160, and the inclined surface 163 of the transfer housing 160 may be aligned with the discharge opening 14b of the feeding head 14. The inclined surface 163 positioned at the lower end of the front opening 164 of the transfer housing 160 may be exposed to the outside through the discharge opening 14b of the feeding head 14.

The crank case 144 may include a first case part 144a and a second case part 144b. The first case part 144a may extend in the length direction of the transfer housing 160, and the second case part 144b may extend in the direction intersecting with the length direction of the transfer housing 160. The second case part 144b may be connected to the first case part 144a. For example, the crank case 144 may be a sunken portion of the moving base 140 that has an overall T shape, and forms a lowered step with respect to the flat plate 141 of the moving base 140. The pin loader 145 may be formed on the bottom surface of the second case part 144b.

When the crank pin 187b may be positioned on the pin loader 145 of the second case part 144b of the crank case 144, the crank body 187a may be positioned on the first case part 144a of the crank case 144. The crank body 187a may be accommodated in the first case part 144a.

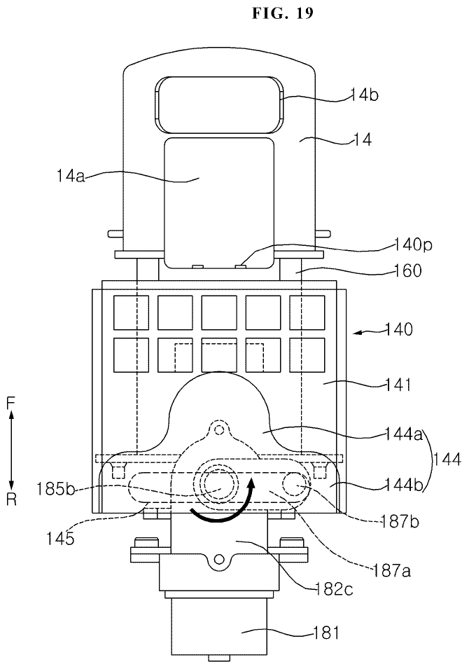

Referring to FIG. 19, when the second shaft 185b rotates 90 degrees counterclockwise based on the second shaft 185b described with reference to FIG. 18, and the second shaft 185b may be positioned in the left-right direction with the crank pin 187b with respect to the crank body 187a, the feeding head 14 may move to the front F of the transfer housing 160, and the discharge opening 14b of the feeding head 14 may move to the front F.

The crank pin 187b may move the moving base 140 in a forward direction by rubbing against the pin loader 145 of the second case part 144b of the crank case 144. The crank body 187a may be positioned in the second case part 144b of the crank case 144. The crank body 187a may be accommodated in the second case part 144b.

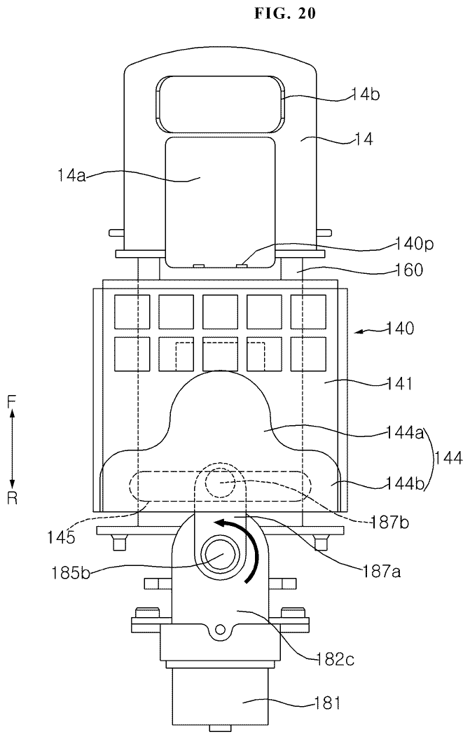

Referring to FIG. 20 together with FIG. 17, when the second shaft 185b rotates 90 degrees counterclockwise based on the second shaft 185b described with reference to FIG. 19, and the second shaft 185b is positioned at the rear R of the crank pin 187b with respect to the crank body 187a, the feeding head 14 may move to the front F of the transfer housing 160, and the discharge opening 14b of the feeding head 14 may move to the front F.

The crank pin 187b may rub against the pin loader 145 of the second case part 144b of the crank case 144 to move the moving base 140 in a forward direction. The crank body 187a may be positioned outside the crank case 144. The crank body 187a may be exposed to the outside of the crank case 144.

After the moving base 140 and the feeding head 14 move from the rear R to the front F, when the composite gear 183 rotates clockwise, the first shaft 184a may rotate counterclockwise. Then, the first bearing 153 may transmit the counterclockwise rotation of the first shaft 184a to the hub 151, and the screw 152 may rotate. At the same time, when the composite gear 183 rotates clockwise, the bevel gear 185b of the second shaft 185a that is engaged with the bevel gear 183b of the composite gear 183 rotates, so that the second shaft 185a may rotate. Then, the second bearing 186 may idle without transmitting the rotation of the second shaft 185a to the crank body 187a.

Accordingly, after the feeding head 14 pops up, the substance (e.g., food) filled in the transfer housing 160 or flowed in through the opening 161 may move from the rear R to the front F of the transfer housing 160 through the screw 152, and may be discharged to the outside of the discharge opening 14b by sliding on the inclined surfaces 163, 14a.

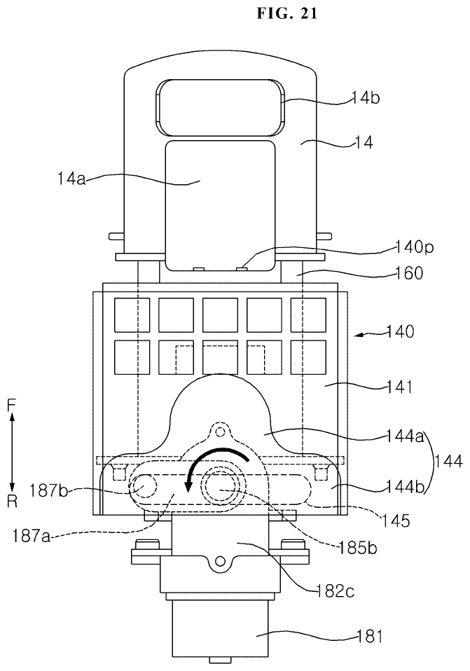

Referring to FIG. 21, when the second shaft 185b rotates 90 degrees counterclockwise based on the second shaft 185b described with reference to FIG. 20, and the second shaft 185b is positioned in the left-right direction with the crank pin 187b with respect to the crank body 187a, the feeding head 14 may move to the rear R of the transfer housing 160, and the discharge opening 14b of the feeding head 14 may move in a rearward direction R.

The crank pin 187b may rub against the pin loader 145 of the second case part 144b of the crank case 144 and move the moving base 140 in a rearward direction. The crank body 187a may be positioned in the second case part 144b of the crank case 144. The crank body 187a may be accommodated in the second case part 144b.

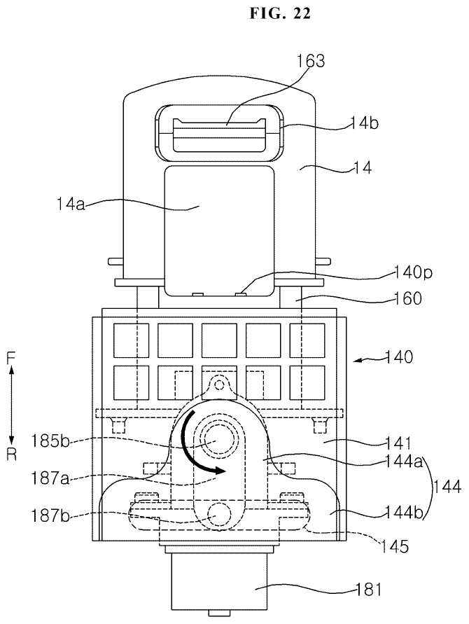

Referring to FIG. 22 together with FIG. 16, when the second shaft 185b is rotated 90 degrees counterclockwise based on the second shaft 185b described with reference to FIG. 21, and the second shaft 185b is positioned in front F of the crank pin 187b with respect to the crank body 187a, the feeding head 14 may cover the front opening 164 (see FIG. 16) of the transfer housing 160, and the inclined surface 163 of the transfer housing 160 may be aligned with the discharge opening 14b of the feeding head 14. The inclined surface 163 positioned at the lower end of the front opening 164 of the transfer housing 160 may be exposed to the outside through the discharge opening 14b of the feeding head 14.

When the crank pin 187b is positioned on the pin loader 145 of the second case part 144b of the crank case 144, the crank body 187a may be positioned in the first case part 144a of the crank case 144. The crank body 187a may be accommodated in the first case part 144a.

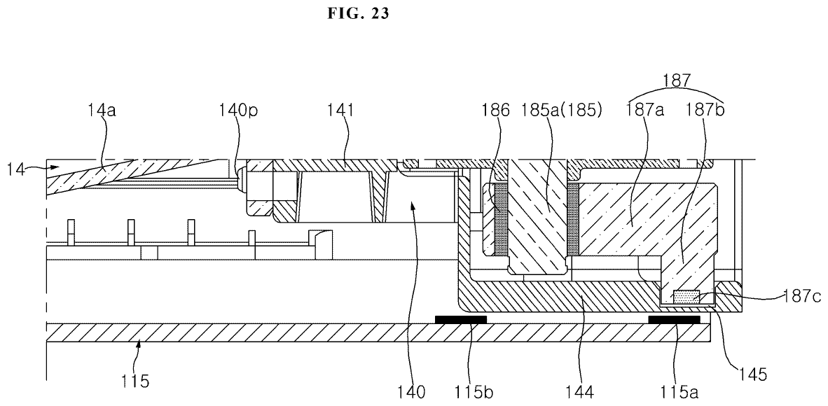

Referring to FIG. 23, the crank pin 187b may include an indicator 187c. The indicator 187c may be embedded in the crank pin 187b or may be fixed to the bottom of the crank pin 187b. When the crank pin 187b moves in a forward-rearward direction in a circular motion about the second shaft 185a, the sensor 115a, 115b mounted on the mount base 115 may detect that the indicator 187c of the crank pin 187b is approaching or moving away. For example, the sensor 115a, 115b may be a hall sensor, and the indicator 187c may be a magnet. As another example, the sensor 115a, 115b may be a proximity sensor, and the indicator 187c may be metal.

Referring to FIGS. 1 to 23, the feeder includes a transfer housing having an opening; a transfer portion rotatable within the transfer housing; a first gear transmitting power to the transfer portion; a motor providing power to the first gear; a second gear receiving power from the motor; and a feeding head which is adjacent to the opening of the transfer housing, and moves by a power transmitted by the second gear, wherein when the motor provides rotational power in a first direction, the feeding head moves, and, when the motor provides rotational power in a second direction opposite to the first direction, the movement of the feeding head stops and the transfer portion rotates.

When the motor changes the rotation from the second direction to the first direction, the rotation of the transfer portion stops and the feeding head moves.

The feeder further includes a composite gear fixed to a rotational shaft of the motor, and the composite gear includes: a first part gear engaged with the first gear; and a second part gear engaged with the second gear.

The first part gear is positioned between the second part gear and the motor, the first part gear is a spur gear, and the second part gear is a bevel gear.

The first gear is fixed to a first shaft, and the first shaft is coupled to the transfer portion and transmits the rotational power.

The transfer portion includes: a hub into which the first shaft is inserted; a screw which is coupled to the hub, and rotates together with the hub; and a first bearing which is inserted into the hub, and into which the screw is inserted, in which the first bearing transmits the rotational power in the second direction to the hub, and idles when the rotational power in the first direction is transmitted from the first shaft.

The feeder further includes: a second shaft fixed to the second gear; a crank pin parallel to the second shaft; a crank body which is connected to the crank pin, and into which the second shaft is inserted; and a second bearing which is inserted into the crank body, and into which the second shaft is inserted.

The second bearing transmits the rotational power in the first direction to the crank body, and idles when the rotational power in the second direction is transmitted from the second shaft.

The feeder further includes a moving base which is positioned between the feeding head and the crank body, and to which the feeding head is fixed, in which the moving base includes: a flat plate to which the feeding head is fixed; and a crank case which forms a step lowered from the flat plate, and accommodates the crank body.

The crank case includes a pin loader which forms a step lowered from a bottom surface of the crank case, and into which the crank pin is inserted.

The crank case includes: a first crank case which extends in a direction toward the feeding head from the motor; and a second crank case which extends in a direction intersecting with the first crank case, and the pin loader is positioned in the second crank case.

The feeder further includes a lower base; an upper base facing the lower base, on the lower base; a moving base which moves between the lower base and the upper base, and to which the feeding head is fixed, in which the lower base includes a side rail which extends in a moving direction of the moving base, and is positioned on a side surface of the moving base, in which the moving base includes a side slider moving on the side rail, in which the side rail includes: a vertical portion facing the side surface of the moving base; and an inclined portion connected to an upper end of the vertical portion, in which the side slider includes a lower side slider placed on the upper end of the vertical portion connected to the inclined portion, in which the lower side slider includes a rounding part protruding downwardly of the lower side slider, in which the rounding part of the lower side slider is in contact with the inclined portion of the side rail.

The side slider further includes an upper side slider which is positioned adjacent to the lower slider, and protrudes upwardly of the moving base, in which the upper base includes a side rail cover which covers at least one of an outer surface of the upper side slider and an outer surface of the lower side slider.

The side rail cover includes: a first rail cover covering an upper surface of the upper side slider; a second rail cover which is connected to the first rail cover, and covers a side surface of the upper side slider; a third rail cover which is connected to the second rail cover, and covers an upper surface of the lower side slider; and a fourth rail cover which is connected to the third rail cover, covers a side surface of the lower side slider, and is supported by the lower base.

The feeder further includes: a tower housing which has the transfer housing embedded therein, and has an opening formed on a side surface; a container positioned above the transfer housing, within the tower housing; an upper base positioned on an opposite side of the container with respect to the transfer housing, within the tower housing; a lower base facing the upper base; and a moving base which moves between the upper base and the lower base, and to which the feeding head is fixed, and when the motor provides rotational power in a first direction, the moving base moves so that the feeding head protrudes outward from the opening of the tower housing or moves into an interior of the tower housing.

The transfer housing includes: a front opening which is the opening that communicates the feeding head with an interior of the transfer housing; and an upper opening which is positioned below the container, and communicates the interior of the transfer housing with an exterior, and the container is aligned with the upper opening of the transfer housing.

The transfer portion includes: a screw formed in a spiral shape; and a hub which is fixed to the screw, and into which a first shaft of the first gear is inserted, and when the motor provides rotational power in the second direction, the transfer portion moves a substance flowing into an upper opening of the transfer housing to a front opening of the transfer housing.

The transfer housing includes an inclined surface connected to a lower portion of the front opening of the transfer housing, and the feeding head includes: an inclined surface aligned with the inclined surface of the transfer housing; and a discharge opening which is connected to the inclined surface of the feeding head, and formed at a lower portion of the feeding head.

The feeder further includes: a first shaft providing a rotational shaft of the first gear; and a second shaft providing a rotational shaft of the second gear, in which a length direction of the first shaft intersects with a length direction of the second shaft.

The feeder further includes: a composite gear which is fixed to a rotational shaft of the motor, and positioned between the first gear and the second gear, in which the composite gear includes: a first part gear engaged with the first gear; and a second part gear engaged with the second gear, in which the first part gear and the first gear are a spur gear, and the second part gear and the second gear are a bevel gear.

The effects of the feeder according to the present disclosure are described as follows.

According to at least one of the embodiments of the present disclosure, an animal feeder can be provided.

According to at least one of the embodiments of the present disclosure, a feeder that automatically supplies food to a pet can be provided.

According to at least one of the embodiments of the present disclosure, a hygienic feeder can be provided.

According to at least one of the embodiments of the present disclosure, a feeder capable of controlling a single food intake can be provided.

According to at least one of the embodiments of the present disclosure, a feeder having improved safety of use can be provided.

According to at least one of the embodiments of the present disclosure, a feeder that can implement two types of driving with single motor can be provided.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A feeder comprising:
a transfer housing having an opening;
a transfer portion rotatable within the transfer housing;
a first gear transmitting power to the transfer portion;
a motor providing power to the first gear;
a second gear receiving power from the motor; and
a feeding head which is adjacent to the opening of the transfer housing, and moves by a power transmitted by the second gear,
wherein when the motor provides rotational power in a first direction, the feeding head moves,
and, when the motor provides rotational power in a second direction opposite to the first direction, the movement of the feeding head stops and the transfer portion rotates.

2. The feeder of claim 1, wherein when the motor changes the rotation from the second direction to the first direction, the rotation of the transfer portion stops and the feeding head moves.

3. The feeder of claim 1, further comprising a composite gear fixed to a rotational shaft of the motor,
wherein the composite gear comprises:
a first part gear engaged with the first gear; and
a second part gear engaged with the second gear.

4. The feeder of claim 3, wherein the first part gear is positioned between the second part gear and the motor,
wherein the first part gear is a spur gear, and the second part gear is a bevel gear.

5. The feeder of claim 3, wherein the first gear is fixed to a first shaft,
wherein the first shaft is coupled to the transfer portion and transmits the rotational power.

6. The feeder of claim 5, wherein the transfer portion comprises:
a hub into which the first shaft is inserted;
a screw which is coupled to the hub, and rotates together with the hub; and
a first bearing which is inserted into the hub, and into which the first shaft is inserted,
wherein the first bearing transmits the rotational power in the second direction to the hub, and idles when the rotational power in the first direction is transmitted from the first shaft.

7. The feeder of claim 3, further comprising:
a second shaft fixed to the second gear;
a crank pin parallel to the second shaft;
a crank body which is connected to the crank pin, and into which the second shaft is inserted; and
a second bearing which is inserted into the crank body, and into which the second shaft is inserted.

8. The feeder of claim 7, wherein the second bearing transmits the rotational power in the first direction to the crank body, and idles when the rotational power in the second direction is transmitted from the second shaft.

9. The feeder of claim 8, further comprising a moving base which is positioned between the feeding head and the crank body, and to which the feeding head is fixed,
wherein the moving base comprises:
a flat plate to which the feeding head is fixed; and
a crank case which forms a step lowered from the flat plate, and accommodates the crank body.

10. The feeder of claim 9, wherein the crank case comprises a pin loader which forms a step lowered from a bottom surface of the crank case, and into which the crank pin is inserted.

11. The feeder of claim 10, wherein the crank case comprises:
a first crank case which extends in a direction toward the feeding head from the motor; and
a second crank case which extends in a direction intersecting with the first crank case,
wherein the pin loader is positioned in the second crank case.

12. The feeder of claim 1, further comprising:
a lower base;
an upper base facing the lower base, on the lower base;
a moving base which moves between the lower base and the upper base, and to which the feeding head is fixed,
wherein the lower base comprises a side rail which extends in a moving direction of the moving base, and is positioned on a side surface of the moving base,
wherein the moving base comprises a side slider moving on the side rail,
wherein the side rail comprises:
a vertical portion facing the side surface of the moving base; and
an inclined portion connected to an upper end of the vertical portion,
wherein the side slider comprises a lower side slider placed on the upper end of the vertical portion connected to the inclined portion,
wherein the lower side slider comprises a rounding part protruding downwardly of the lower side slider,
wherein the rounding part of the lower side slider is in contact with the inclined portion of the side rail.

13. The feeder of claim 12, wherein the side slider further comprises an upper side slider which is positioned adjacent to the lower slider, and protrudes upwardly of the moving base,
wherein the upper base comprises a side rail cover which covers at least one of an outer surface of the upper side slider and an outer surface of the lower side slider.

14. The feeder of claim 13, wherein the side rail cover comprises:
a first rail cover covering an upper surface of the upper side slider;
a second rail cover which is connected to the first rail cover, and covers a side surface of the upper side slider;
a third rail cover which is connected to the second rail cover, and covers an upper surface of the lower side slider; and
a fourth rail cover which is connected to the third rail cover, covers a side surface of the lower side slider, and is supported by the lower base.

15. The feeder of claim 1, further comprising:
a tower housing which has the transfer housing embedded therein, and has an opening formed on a side surface;
a container positioned above the transfer housing, within the tower housing;
an upper base positioned on an opposite side of the container with respect to the transfer housing, within the tower housing;
a lower base facing the upper base; and
a moving base which moves between the upper base and the lower base, and to which the feeding head is fixed,
wherein when the motor provides rotational power in a first direction, the moving base moves so that the feeding head protrudes outward from the opening of the tower housing or moves into an interior of the tower housing.

16. The feeder of claim 15, wherein the transfer housing comprises:
a front opening which is the opening that communicates the feeding head with an interior of the transfer housing; and
an upper opening which is positioned below the container, and communicates the interior of the transfer housing with an exterior,
wherein the container is aligned with the upper opening of the transfer housing.

17. The feeder of claim 16, wherein the transfer portion comprises:
a screw formed in a spiral shape; and
a hub which is fixed to the screw, and into which a first shaft of the first gear is inserted,
wherein when the motor provides rotational power in the second direction, the transfer portion moves a substance flowing into an upper opening of the transfer housing to a front opening of the transfer housing.

18. The feeder of claim 17, wherein the transfer housing comprises an inclined surface connected to a lower portion of the front opening of the transfer housing,
wherein the feeding head comprises:
an inclined surface aligned with the inclined surface of the transfer housing; and
a discharge opening which is connected to the inclined surface of the feeding head, and formed at a lower portion of the feeding head.

19. The feeder of claim 1, further comprising:
a first shaft providing a rotational shaft of the first gear; and
a second shaft providing a rotational shaft of the second gear,
wherein a length direction of the first shaft intersects with a length direction of the second shaft.

20. The feeder of claim 19, further comprising:
a composite gear which is fixed to a rotational shaft of the motor, and positioned between the first gear and the second gear,
wherein the composite gear comprises:
a first part gear engaged with the first gear; and
a second part gear engaged with the second gear,
wherein the first part gear and the first gear are a spur gear, and the second part gear and the second gear are a bevel gear.
